(19) United States
(12) Patent Application Publication
(10) Pub. No.: US 2024/0121023 A1
(43) Pub. Date: Apr. 11, 2024

(54) WIRELESS COMMUNICATION MANAGEMENT APPARATUS, WIRELESS COMMUNICATION MANAGEMENT METHOD, AND WIRELESS COMMUNICATION MANAGEMENT PROGRAM

(71) Applicant: NIPPON TELEGRAPH AND TELEPHONE CORPORATION, Tokyo (JP)

(72) Inventors: Shoko SHINOHARA, Musashino-shi (JP); Yasuhiko INOUE, Musashino-shi (JP); Yusuke ASAI, Musashino-shi (JP); Yasushi TAKATORI, Musashino-shi (JP)

(73) Assignee: NIPPON TELEGRAPH AND TELEPHONE CORPORATION, Tokyo (JP)

(21) Appl. No.: 18/269,029

(22) PCT Filed: Dec. 25, 2020
(86) PCT No.: PCT/JP2020/048624

§ 371 Date: Jun. 22, 2023

(51) Int. Cl. H04L 1/00; H04L 1/20; H04W 28/04

(52) U.S. Cl. CPC H04L 1/0003; H04L 1/0009; H04L 1/203; H04W 28/04; H04W 84/12

(57) ABSTRACT

A wireless communication management apparatus (100) includes a correction unit (1131), an evaluation unit (1132), and a determination unit (1133). The correction unit (1131) corrects, on the basis of a characteristic of each terminal, an error rate in wireless communication between a base station and the terminal based on wireless environment information collected from one or more terminals configured to wirelessly communicate with the base station. The evaluation unit (1132) evaluates the corrected error rate. The determination unit (1133) determines a modulation/demodulation scheme for each terminal on the basis of the evaluation result of the evaluation unit.

### TECHNICAL FIELD

An embodiment relates to a wireless communication management apparatus, a wireless communication management method, and a wireless communication management program.

### BACKGROUND ART

A wireless communication system including a base station and a terminal is known. In recent years, a wireless LAN for industrial use has appeared in wireless communication systems. As a wireless LAN for industrial use, for example, a use case in which data measured by an Internet of things (IoT) terminal is transmitted to a base station is assumed.

### CITATION LIST

### Non Patent Literature

Non Patent Literature 1: ARIB STD-T108 1.3, “920 MHz-Band Telemeter, Telecontrol and Data Transmission Radio Equipment and Standards”, Apr. 12, 2019 Non Patent Literature 2: IEEE Std 802.11ah TM-2016 (IEEE Standard for Information technology—Telecommunications and information exchange between systems Local and metropolitan area networks—Specific requirements, Part 11:Wireless LAN Medium Access Control (MAC) and Physical Layer (PHY) Specifications, Amendment 2:Sub 1 GHz License Exempt Operation, IEEE Computer Society, 7 Dec. 2016

### SUMMARY OF INVENTION

### Technical Problem

One of transmission parameters in a wireless LAN system is a modulation/demodulation scheme. Conventionally, when selecting a modulation/demodulation scheme, a signal to interference and noise ratio (SINR) is calculated on the basis of a received signal strength indication (RSSI) value as a level of a received power value assuming that there is no noise other than thermal noise, and a modulation and coding scheme (MCS) corresponding to an optimal modulation/demodulation scheme is selected on the basis of the SINR. In addition, when a retransmission frame occurs during communication, control may be performed to lower the MCS according to the error rate because the initially set MCS has a high error rate.

Here, in a case where the MCS is controlled for each IoT terminal, the error rate receives bias due to characteristics of each IoT terminal. If this bias is not considered, control for unnecessarily lowering the MCS is performed.

An object of the embodiment is to provide a wireless communication management apparatus, a wireless communication management method, and a wireless communication management program capable of selecting an optimal MCS for each terminal.

### Solution to Problem

A wireless communication management apparatus of one aspect includes a correction unit, an evaluation unit, and a determination unit. The correction unit corrects, on the basis of a characteristic of each terminal, an error rate in wireless communication between a base station and the terminal based on wireless environment information collected from one or more terminals configured to wirelessly communicate with the base station. The evaluation unit evaluates the corrected error rate. The determination unit determines a modulation/demodulation scheme for each terminal on the basis of the evaluation result of the evaluation unit.

### Advantageous Effects of Invention

According to the embodiment, it is possible to provide a wireless communication management apparatus, a wireless communication management method, and a wireless communication management program capable of selecting an optimal MCS for each terminal.

### BRIEF DESCRIPTION OF DRAWINGS

FIG. 1 is a block diagram illustrating an example of a configuration of a communication system according to an embodiment.

FIG. 2 is a block diagram illustrating an example of a hardware configuration of a wireless communication management apparatus according to the embodiment.

FIG. 3 is a block diagram illustrating an example of a hardware configuration of a base station according to the embodiment.

FIG. 4 is a block diagram illustrating an example of a hardware configuration of a terminal according to the embodiment.

FIG. 5 is a block diagram illustrating an example of a functional configuration of the wireless communication management apparatus according to the embodiment.

FIG. 6 is a block diagram illustrating a functional configuration of an example of a control information generation unit.

FIG. 7 is a block diagram illustrating an example of a functional configuration of the base station according to the embodiment.

FIG. 8 is a block diagram illustrating an example of a functional configuration of the terminal according to the embodiment.

FIG. 9 is a flowchart illustrating an example of the wireless communication management operation in the wireless communication management apparatus according to the embodiment.

FIG. 10 is a flowchart illustrating an example of modulation/demodulation scheme determination processing as control information generation processing.

FIG. 11A is a diagram illustrating an example of an SINR-PER-MCS conversion table when an MTU is 1500 bytes.

FIG. 11B is a diagram illustrating the example of the SINR-PER-MCS conversion table when the MTU is 1500 bytes.

FIG. 12 is a diagram illustrating an example of an SINR-optimal MCS table.

FIG. 13 is a diagram illustrating an example of an MCS-aggregation number conversion table.

### DESCRIPTION OF EMBODIMENTS

Hereinafter, an embodiment will be described with reference to the drawings. Note that in the following description, components having the same function and configuration are denoted by the same reference signs. In addition, when distinguishing among a plurality of components having a common reference sign, the component is distinguished by an additional reference sign (e.g., hyphen and number such as “−1”) attached after the common reference sign.

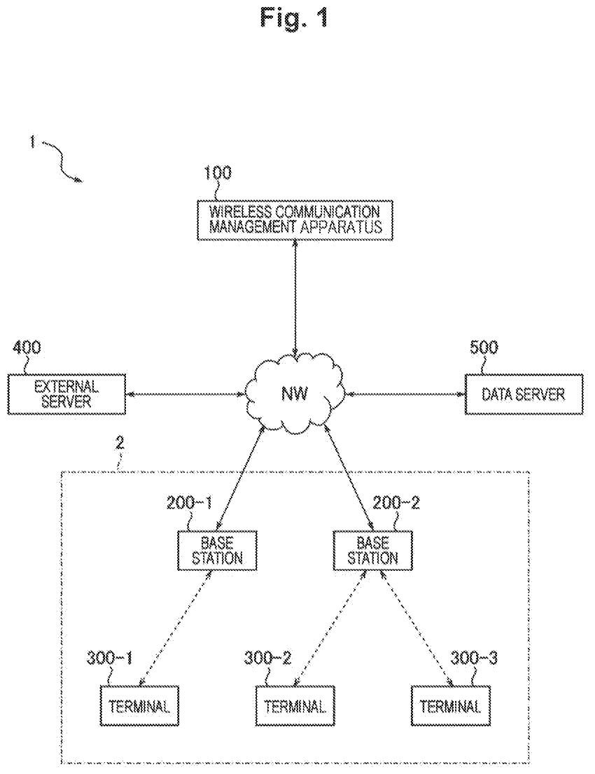

First, a configuration of the communication system according to the embodiment will be described. FIG. 1 is a block diagram illustrating an example of the configuration of the communication system according to the embodiment. As illustrated in FIG. 1, a communication system 1 is a system that manages a wireless environment of a wireless communication system 2. The communication system 1 includes a wireless communication management apparatus 100, a plurality of base stations 200-1 and 200-2, a plurality of terminals 300-1, 300-2, and 300-3, an external server 400, and a data server 500. The plurality of base stations 200-1 and 200-2 and the plurality of terminals 300-1 to 300-3 form the wireless communication system 2.

Hereinafter, each of the plurality of base stations 200-1 and 200-2 may be referred to as “base station 200” unless otherwise distinguished. Each of the plurality of terminals 300-1 to 300-3 may be referred to as “terminal 300” unless otherwise distinguished. Furthermore, the base station 200 and the terminal 300 may be collectively referred to as “device”.

The wireless communication system 2 is a wireless communication system for industrial use. The wireless communication system 2 is configured to use a frequency band (unlicensed band) that can be used without a wireless station license. In the wireless communication system 2, for example, a sub-GHz band is used as an unlicensed band. The sub-GHz band includes, for example, the 920 MHz band.

The wireless communication management apparatus 100 is an on-premises data processing server for managing a wireless environment of the wireless communication system 2. The wireless communication management apparatus 100 is configured to establish wired connection with the base station 200, the external server 400, and the data server 500 via, for example, a router or a hub (not illustrated) in a network NW.

The base station 200 is a master unit (AP: access point) of the wireless communication system 2. The base station 200 is configured to connect the terminal 300 and the wireless communication management apparatus 100 and connect the terminal 300 and the data server 500 via the network NW.

The terminal 300 is a slave unit (STA: station) of the wireless communication system 2. The terminal 300 is, for example, an IoT terminal including a sensor. The terminal 300 is configured to wirelessly connect to a corresponding base station 200.

In the example of FIG. 1, the terminal 300-1 is configured to wirelessly connect to the base station 200-1. The terminals 300-2 and 300-3 are configured to wirelessly connect to the base station 200-2. However, the terminal 300-1 may also be configured to wirelessly connect to the base station 200-2. The terminals 300-2 and 300-3 may also be configured to wirelessly connect to the base station 200-1. In this manner, the wireless connection between the terminal 300 and the base station 200 may be appropriately selected from a plurality of paths.

The external server 400 is a server that stores information (external environment information) regarding the external environment of the wireless communication system 2.

The data server 500 is a server in which sensor information measured by the wireless communication system 2 is aggregated and stored.

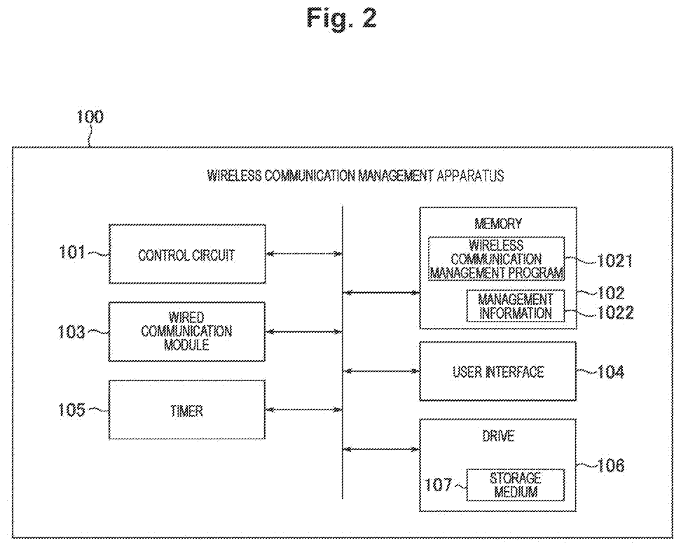

FIG. 2 is a block diagram illustrating an example of a hardware configuration of the wireless communication management apparatus according to the embodiment. The wireless communication management apparatus 100 includes a control circuit 101, a memory 102, a wired communication module 103, a user interface 104, a timer 105, and a drive 106.

The control circuit 101 is a circuit that has overall control of the components of the wireless communication management apparatus 100. The control circuit 101 includes a processor such as a central processing unit (CPU), a random access memory (RAM), a read only memory (ROM), and the like.

The memory 102 is an auxiliary storage device of the wireless communication management apparatus 100. The memory 102 includes, for example, a hard disk drive (HDD), a solid state drive (SSD), a memory card, and the like. The memory 102 stores a wireless communication management program 1021. The wireless communication management program 1021 is a program for causing the control circuit 101 to perform a wireless communication management operation. The wireless communication management operation is a series of operations performed to appropriately manage a wireless communication environment in the wireless communication system 2. The wireless communication management program 1021 can be stored in the memory 102 by being transmitted from outside the wireless communication management apparatus 100 via the network NW.

In addition, the memory 102 stores management information 1022 used for the wireless communication management operation. The management information 1022 includes a correction value of the error rate for each terminal and various tables.

The correction value is a correction value of a packet error rate (PER) used when a modulation/demodulation scheme as one of transmission parameters at the time of wireless communication is determined for each terminal. The PER can be actually measured from a ratio between the number of transmission packets and the number of reception failure packets for each terminal. The correction value is used to absorb variations in PER for each terminal caused by bias due to characteristics of each terminal.

In addition, the various tables include, for example, a SINR-PER-MCS conversion table, a SINR-optimal MCS conversion table, and an MCS-aggregation number conversion table. These tables can be created by various methods such as actual measurement and simulation. Actual measurement is performed, for example, under a wireless environment in which there is no interference with the base station 200 and the terminal 300 from another terminal or the like. Note that the various tables are not necessarily stored in the form of a table. Instead of the various tables, a mathematical expression or the like having a similar input/output relationship may be stored.

The SINR-PER-MCS conversion table is a table indicating a correspondence between SINR and PER for each MCS and for each transmission packet size (maximum transfer unit: MTU). The SINR is an index representing a ratio of interference and noise to a received signal. The MCS is an index associated with each combination of the modulation/demodulation scheme and the coding rate. In the embodiment, a SINR-PER-MCS conversion table is used to calculate an assumed PER and a substantial RSSI value. The assumed PER and the substantial RSSI value will be described later.

The SINR-optimal MCS conversion table is a table indicating a correspondence between a range of SINR and an optimal MCS. An optimal MCS is an MCS that has the highest throughput, that is, can perform high-speed communication and can perform wireless communication with few errors with respect to the corresponding range of SINR. That is, an optimal MCS is the maximum MCS that makes the PER smaller than a predetermined value.

The MCS-aggregation number conversion table is a table in which the optimal aggregation number is associated for each bandwidth and each MCS. An aggregation number is the number of connected frames to be wirelessly communicated.

The wired communication module 103 is a circuit used for transmission and reception of data by a wired signal. The wired communication module 103 is configured, for example, to conform to the TCP/IP hierarchical model. Specifically, for example, a configuration of the wired communication module 103 corresponding to the network interface layer is compliant with Ethernet. A configuration of the wired communication module 103 corresponding to the Internet layer is compliant with the Internet protocol (IP). A configuration of the wired communication module 103 corresponding to the transport layer is compliant with the transmission control protocol (TCP). A configuration of the wired communication module 103 corresponding to the application layer is compliant with the Secure shell (SSH).

The user interface 104 is a circuit for communicating information between the user and the control circuit 101. The user interface 104 includes an input device and a display device. The input device includes, for example, a touch panel, an operation button, and the like. The display device includes, for example, a liquid crystal display (LCD), an electroluminescence (EL) display, and the like. The user interface 104 converts an input from the user into an electrical signal, and then transmits the electrical signal to the control circuit 101.

The timer 105 is a circuit that measures time. For example, the timer 105 starts counting on the basis of a start instruction from the control circuit 101. When the count value becomes equal to or larger than a threshold in the set state, the timer 105 notifies the control circuit 101 of a timeout. The timer 105 ends counting on the basis of an end instruction from the control circuit 101.

The drive 106 is a device for reading a program stored in a storage medium 107. The drive 106 includes, for example, a compact disk (CD) drive, a digital versatile disk (DVD) drive, and the like.

The storage medium 107 is a medium that stores information such as programs by electrical, magnetic, optical, mechanical, or chemical action. The storage medium 107 may store the wireless communication management program.

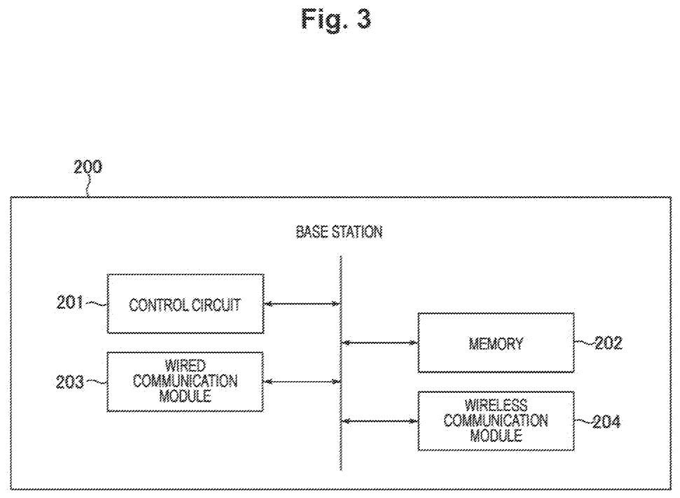

FIG. 3 is a block diagram illustrating an example of a hardware configuration of the base station according to the embodiment. As illustrated in FIG. 3, the base station 200 includes a control circuit 201, a memory 202, a wired communication module 203, and a wireless communication module 204.

The control circuit 201 is a circuit that has overall control of the component of the base station 200. The control circuit 201 includes a processor such as a CPU, a RAM, a ROM, and the like.

The memory 202 is an auxiliary storage device of the base station 200. The memory 202 includes, for example, an HDD, an SSD, a memory card, and the like. The memory 202 stores control information of the base station 200 generated by the wireless communication management apparatus 100 in the wireless communication management operation.

The wired communication module 203 is a circuit used for transmission and reception of data by a wired signal. The wired communication module 203 conforms to a protocol stack equivalent to that of the wired communication module 103. With this configuration, the wired communication module 203 can be connected to the wired communication module 103 by wire.

The wireless communication module 204 is a circuit used for transmission and reception of data by a wireless signal. The wireless communication module 204 is connected to an antenna (not illustrated). The wireless communication module 204 is configured, for example, to conform to the TCP/IP hierarchical model. Specifically, for example, a configuration of the wireless communication module 204 corresponding to the network interface layer is compliant with Institute of electrical and electronics engineers (IEEE) 802.11 ah. A configuration of the wireless communication module 204 corresponding to the Internet layer is compliant with the IP. A configuration of the wireless communication module 204 corresponding to the transport layer is compliant with the TCP. A configuration of the wireless communication module 204 corresponding to the application layer is compliant with the SSH.

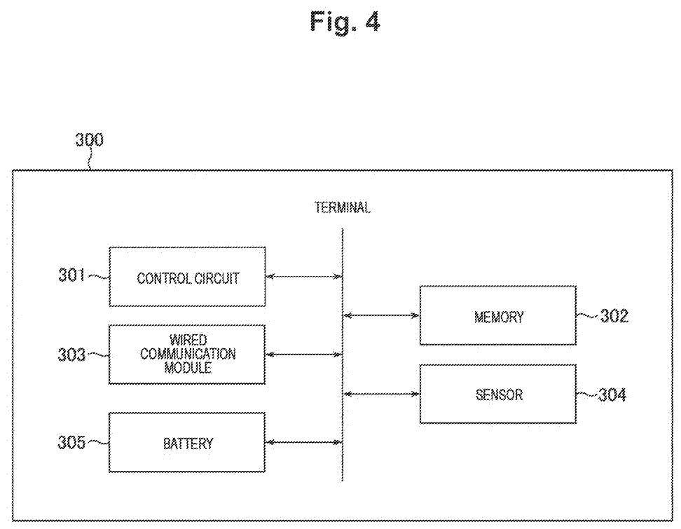

FIG. 4 is a block diagram illustrating an example of a hardware configuration of the terminal according to the embodiment. As illustrated in FIG. 4, the terminal 300 includes a control circuit 301, a memory 302, a wireless communication module 303, a sensor 304, and a battery 305.

The control circuit 301 is a circuit that has overall control of the components of the terminal 300. The control circuit 301 includes a processor such as a CPU, a RAM, a ROM, and the like.

The memory 302 is an auxiliary storage device of the terminal 300. The memory 302 includes, for example, an HDD, an SSD, a memory card, and the like. The memory 302 stores control information generated by the wireless communication management apparatus 100 in the wireless communication management operation and sensor information measured by the sensor 304.

The wireless communication module 303 is a circuit used for transmission and reception of data by a wireless signal. The wireless communication module 303 conforms to a protocol stack equivalent to that of the wireless communication module 204. With this configuration, the wireless communication module 303 can be wirelessly connected to the wireless communication module 204.

The sensor 304 is a circuit that measures data monitored by the wireless communication system 2. Sensor information measured by the sensor 304 is aggregated in the data server 500 via the base station 200 and the network NW.

The battery 305 is a battery for supplying power to the terminal 300. The battery 305 is charged by, for example, a solar power generation module (not illustrated). Note that while FIG. 4 describes a case where the power is supplied with the terminal 300 by charging the battery 305 by solar power generation, the embodiment is not limited thereto. For example, the terminal 300 may be supplied with power by various power supplies.

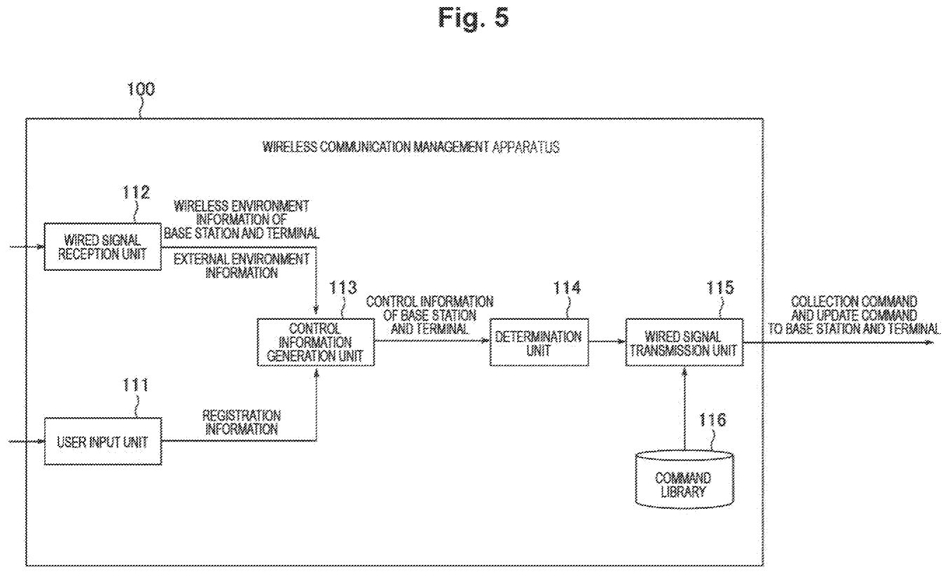

FIG. 5 is a block diagram illustrating an example of a functional configuration of the wireless communication management apparatus according to the embodiment. The wireless communication management apparatus 100 includes a user input unit 111, a wired signal reception unit 112, a control information generation unit 113, a determination unit 114, and a wired signal transmission unit 115. The processor of the control circuit 101 loads the wireless communication management program stored in the memory 102 or the storage medium 107 into the RAM. Then, the processor of the control circuit 101 interprets and executes the wireless communication management program loaded into the RAM to operate as the user input unit 111, the wired signal reception unit 112, the control information generation unit 113, the determination unit 114, and the wired signal transmission unit 115.

The user input unit 111 transmits registration information input by the user to the control information generation unit 113. Registration information includes device information and constraint information.

Device information is information for the wireless communication management apparatus 100 to uniquely identify the base station 200 and the terminal 300. Device information includes, for example, a username, a password, an IP address, and the like for each of the base station 200 and the terminal 300. A username, a password, and an IP address are used for the wireless communication management apparatus 100 to remotely log in to the base station 200 and the terminal 300 using a protocol such as SSH.

Constraint information is information indicating constraint conditions to be complied with by the wireless communication system 2 on the basis of laws such as the Radio law. Constraint information includes, for example, an upper limit value of the total transmission time for each device.

The wired signal reception unit 112 receives wireless environment information of the base station 200 and the terminal 300 from the base station 200. The wired signal reception unit 112 receives external environment information from the external server 400. The wired signal reception unit 112 transmits the received pieces of environment information to the control information generation unit 113.

Wireless environment information is information collected from the base station 200 and the terminal 300 to evaluate the throughput of wireless communication in the wireless communication management operation. Wireless environment information includes, for example, an SSID, a channel, a bandwidth, a frequency, a received signal strength indication (RSSI) value, a PER, an MCS, an MTU, and the like of a peripheral basic service set (BSS) as information common to the base station 200 and the terminal 300. Furthermore, wireless environment information can include, for example, information indicating the remaining capacity of the battery 305 as information specific to the terminal 300.

External environment information is information collected from the external server 400 to evaluate the throughput of wireless communication. External environment information includes, for example, a predicted value of sunshine hours in an area where the wireless communication system 2 is provided.

The control information generation unit 113 generates control information of the base station 200 and the terminal 300 on the basis of registration information, wireless environment information of the base station 200 and the terminal 300, and external environment information. The control information generation unit 113 may store the received pieces of information in the memory 102 until all the information used for the wireless communication management operation is prepared. Control information is information used for constructing a wireless communication environment of the base station 200 and the terminal 300. The control information of a certain device is generated on the basis of at least the wireless environment information collected from the certain device. The control information of a certain device can be generated further on the basis of wireless environment information collected from devices other than the certain device. Control information includes transmission parameters, channels, and transmission rates of the base station 200 and the terminal 300. In addition, control information includes information indicating transmission time zones and a transmission frequency (duty ratio) of the base station 200 and the terminal 300.

The determination unit 114 determines whether or not to update the setting of the wireless environment by the generated control information for each of the base station 200 and the terminal 300 for which the control information has been generated. In addition, the determination unit 114 further determines, for each of the base station 200 and the terminal 300 determined to update the setting of the wireless environment, whether or not the update involves a restart. The determination unit 114 transmits a set of control information and a determination result for each of the base station 200 and the terminal 300 to the wired signal transmission unit 115.

The wired signal transmission unit 115 generates various commands for controlling the base station 200 and the terminal 300 on the basis of an instruction from the control circuit 101. The various commands are generated with reference to the command library 116.

The command library 116 stores in advance a command group used for the wireless communication management operation. The command library 116 stores, for example, a collection command and an update command. The collection command is a command for collecting wireless environment information from the designated base station 200 or terminal 300 (designated by IP address or the like). The update command is a command for updating the setting of the wireless environment of the designated base station 200 or terminal 300 (designated by IP address or the like) with the control information. Therefore, the update command includes control information for updating the setting of the wireless environment of the designated base station 200 or terminal 300. In addition, the update command may include an instruction to restart the designated base station 200 or terminal 300.

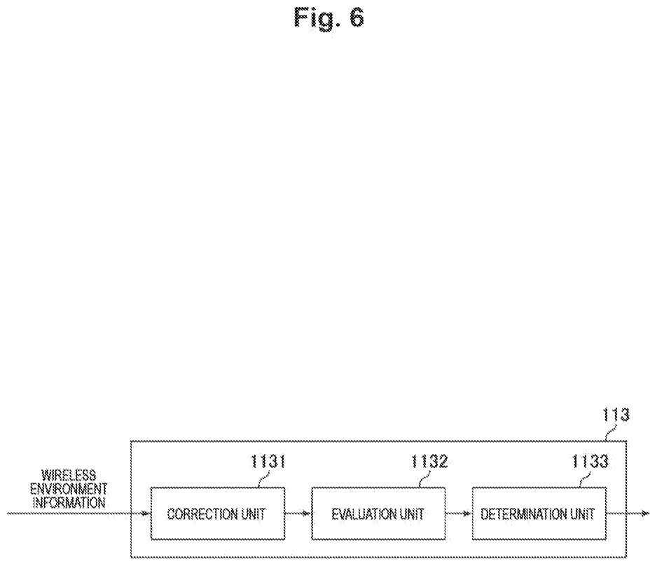

FIG. 6 is a block diagram illustrating a functional configuration of an example of the control information generation unit 113. The control information generation unit 113 determines an MCS which is one of the transmission parameters. The control information generation unit 113 includes a correction unit 1131, an evaluation unit 1132, and a determination unit 1133. The correction unit 1131 corrects the PER based on the wireless environment information collected from the terminal 300, on the basis of the characteristics of each terminal 300. The evaluation unit 1132 evaluates the PER corrected by the correction unit 1131. The determination unit 1133 determines the optimal MCS for each terminal 300 on the basis of the result evaluated by the evaluation unit 1132. At this time, when the corrected PER is different from the assumed PER, the determination unit 1133 determines the optimal MCS by using the substantial RSSI value instead of the RSSI value collected from the terminal 300. Further, the determination unit 1133 determines the MTU and the aggregation number by using the determined optimal MCS.

Here, the control information generation unit 113 may determine various transmission parameters other than the MCS. Various transmission parameters other than the MCS can be arbitrarily determined. Therefore, description thereof is omitted.

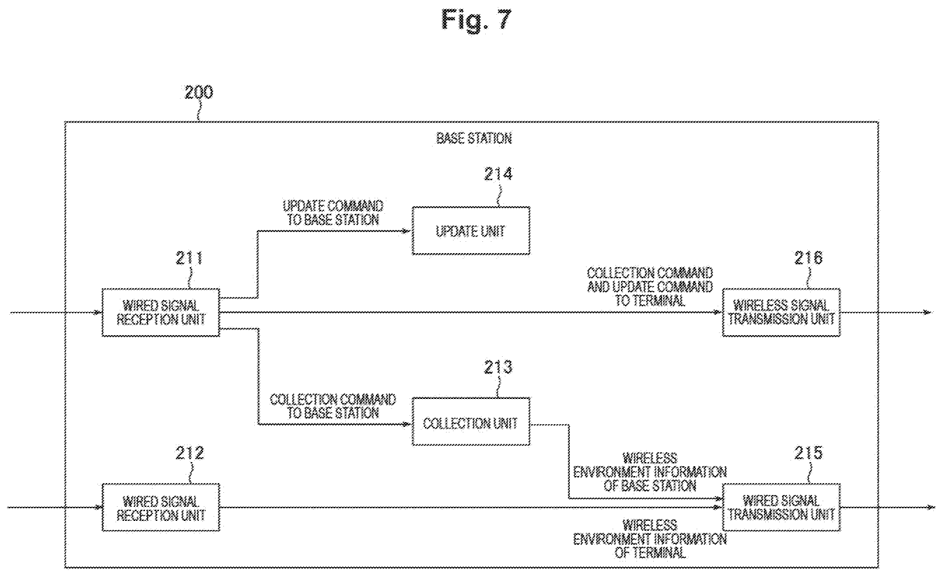

FIG. 7 is a block diagram illustrating an example of a functional configuration of the base station according to the embodiment. The base station 200 includes a wired signal reception unit 211, a wireless signal reception unit 212, a collection unit 213, an update unit 214, a wired signal transmission unit 215, and a wireless signal transmission unit 216. The processor of the control circuit 201 operates as the wired signal reception unit 211, the wireless signal reception unit 212, the collection unit 213, the update unit 214, the wired signal transmission unit 215, and the wireless signal transmission unit 216 on the basis of various commands transmitted from the wireless communication management apparatus 100.

The wired signal reception unit 211 receives a collection command and an update command from the wireless communication management apparatus 100. When receiving a collection command (to base station 200) addressed to the base station 200, the wired signal reception unit 211 transmits the collection command to the collection unit 213. When receiving an update command to the base station 200, the wired signal reception unit 211 transmits the update command to the update unit 214. When receiving a collection command and an update command (to terminal 300) addressed to the terminal 300, the wired signal reception unit 211 transmits the collection command and the update command to the wireless signal transmission unit 216. When data is transmitted from the wired signal reception unit 211 to the wireless signal transmission unit 216, the data is converted from the Ethernet frame format to the 802.11 ah frame format.

The wireless signal reception unit 212 receives wireless environment information of the terminal 300 from the terminal 300. The wireless signal reception unit 212 transmits the received wireless environment information of the terminal 300 to the wired signal transmission unit 215. When data is transmitted from the wireless signal reception unit 212 to the wired signal transmission unit 215, the data is converted from the 802.11 ah frame format to the Ethernet frame format.

The collection unit 213 collects wireless environment information of the base station 200 on the basis of the received collection command. The collection unit 213 transmits the collected wireless environment information of the base station 200 to the wired signal transmission unit 215.

The update unit 214 updates the setting of the wireless environment of the base station 200 with control information in the update command on the basis of the received update command. When the update command includes a restart instruction, the update unit 214 restarts the base station 200.

The wired signal transmission unit 215 transmits the received wireless environment information of the base station 200 to the wireless communication management apparatus 100. The wired signal transmission unit 215 transfers the received wireless environment information of the terminal 300 to the wireless communication management apparatus 100.

The wireless signal transmission unit 216 transfers the received collection command and update command of the terminal 300 to the terminal 300.

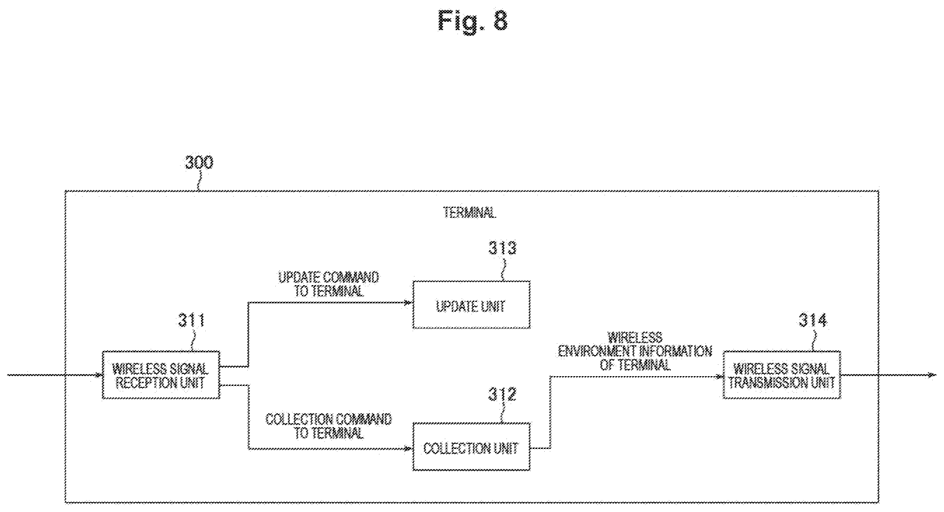

FIG. 8 is a block diagram illustrating an example of a functional configuration of the terminal according to the embodiment. The processor of the control circuit 301 operates as the wireless signal reception unit 311, the collection unit 312, the update unit 313, and the wireless signal transmission unit 314 on the basis of various commands transmitted from the wireless communication management apparatus 100.

The wireless signal reception unit 311 receives a collection command and an update command from the base station 200. The wireless signal reception unit 311 transmits the collection command to the collection unit 312, and transmits the update command to the update unit 313.

The collection unit 312 collects wireless environment information of the terminal 300 on the basis of the received collection command. The collection unit 312 transmits the collected wireless environment information of the terminal 300 to the wireless signal transmission unit 314.

The update unit 313 updates the setting of the wireless environment of the terminal 300 with control information in the update command on the basis of the received update command. When the update command includes a restart instruction, the update unit 313 restarts the terminal 300.

The wireless signal transmission unit 314 transmits the received wireless environment information of the terminal 300 to the base station 200.

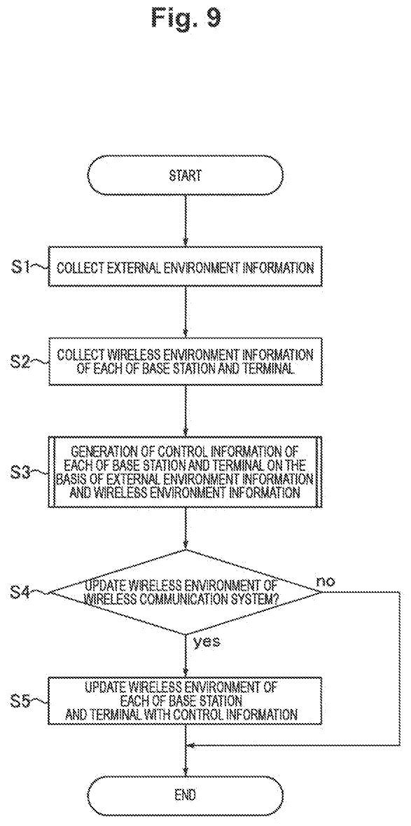

Next, an operation of the communication system according to the embodiment will be described. FIG. 9 is a flowchart illustrating an example of the wireless communication management operation in the wireless communication management apparatus according to the embodiment. In FIG. 9, it is assumed that registration information is stored in the memory 102 in advance by user input. In addition, it is assumed that the wireless communication management apparatus 100 has remotely logged in to each device stored in the registration information using a protocol such as SSH.

As illustrated in FIG. 9, when a start condition of a wireless communication monitoring operation such as elapse of a predetermined time interval is satisfied, in step S1, the wireless communication management apparatus 100 collects external environment information from the external server 400. External environment information includes, for example, a predicted value of sunshine hours in an area where the wireless communication system 2 is provided.

In step S2, the wireless communication management apparatus 100 collects wireless environment information from each of the base station 200 and the terminal 300. The wireless environment information includes an MCS, an MTU, and measured values of an RSSI value and a PER. The processing of step S2 may be performed before the processing of step S1, or may be performed in parallel with the processing of step S1.

In step S3, the wireless communication management apparatus 100 generates control information of each of the base station 200 and the terminal 300 on the basis of the collected external environment information and wireless environment information. Details of the processing of step S3 will be described later.

In step S4, the wireless communication management apparatus 100 determines whether or not to update the setting of the wireless environment of the wireless communication system 2. If it is determined in step S4 to update the setting of the wireless environment, the processing proceeds to step S5. If it is determined in step S4 not to update the setting of the wireless environment, the wireless communication management operation ends.

In step S5, the wireless communication management apparatus 100 updates the setting of the wireless environment of each of the base station 200 and the terminal 300 with the control information. When the processing of step S5 ends, the wireless communication management operation ends.

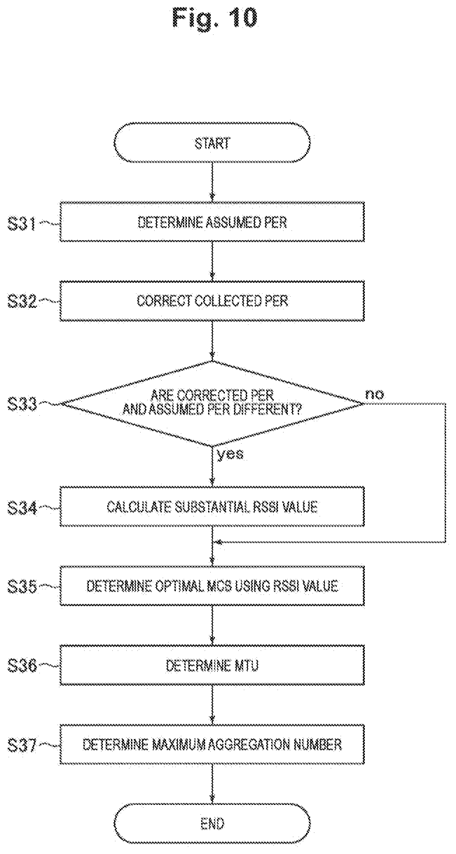

FIG. 10 is a flowchart illustrating an example of modulation/demodulation scheme determination processing as control information generation processing. In step S31, the wireless communication management apparatus 100 determines the assumed PER. The assumed PER is a PER value calculated on the basis of the collected RSSI value and the MTU and MCS set at the time of wireless communication, and is a PER value assumed under a wireless environment without interference or the like. Here, an example of a method of determining the assumed PER will be described.

First, the wireless communication management apparatus 100 calculates the SINR by using the collected RSSI value. The SINR is calculated according to the following (Equation 1).

SINR[dB]=RSSI[dBm]−N[dBm] (Equation 1)

Here, N in (Equation 1) is a noise floor value assumed at the time of wireless communication. N is predetermined according to the bandwidth. For example, the noise floor value N when the bandwidth is 1 MHz is −99 dBm, the noise floor value N when the bandwidth is 2 MHz is −96 dBm, and the noise floor value N when the bandwidth is 4 MHz is −93 dBm. Therefore, for example, if the bandwidth is 1 MHz and the collected RSSI value is −45 dBm, the SINR is 54 dB.

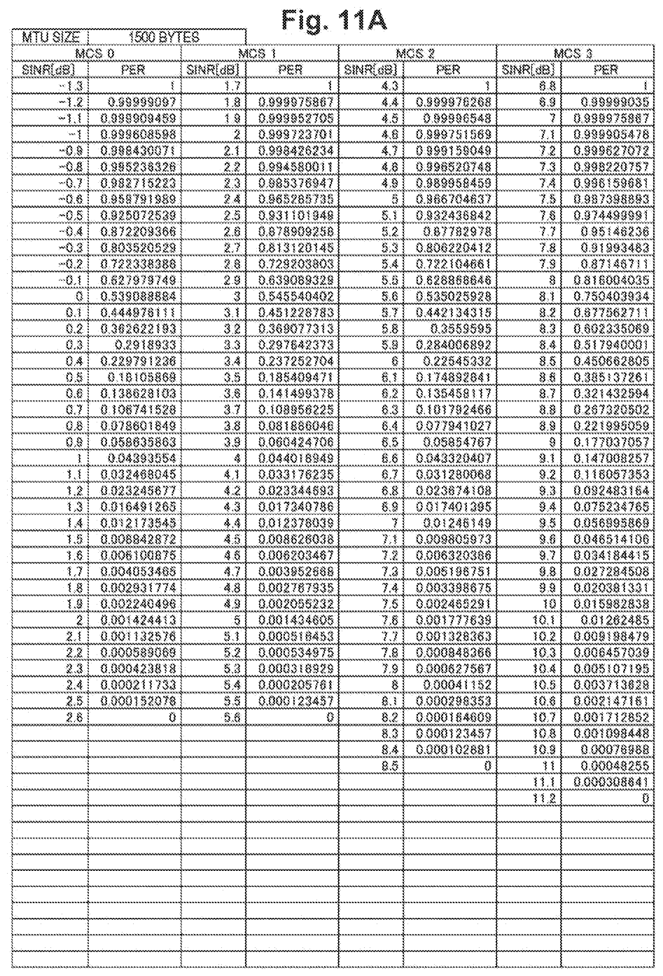

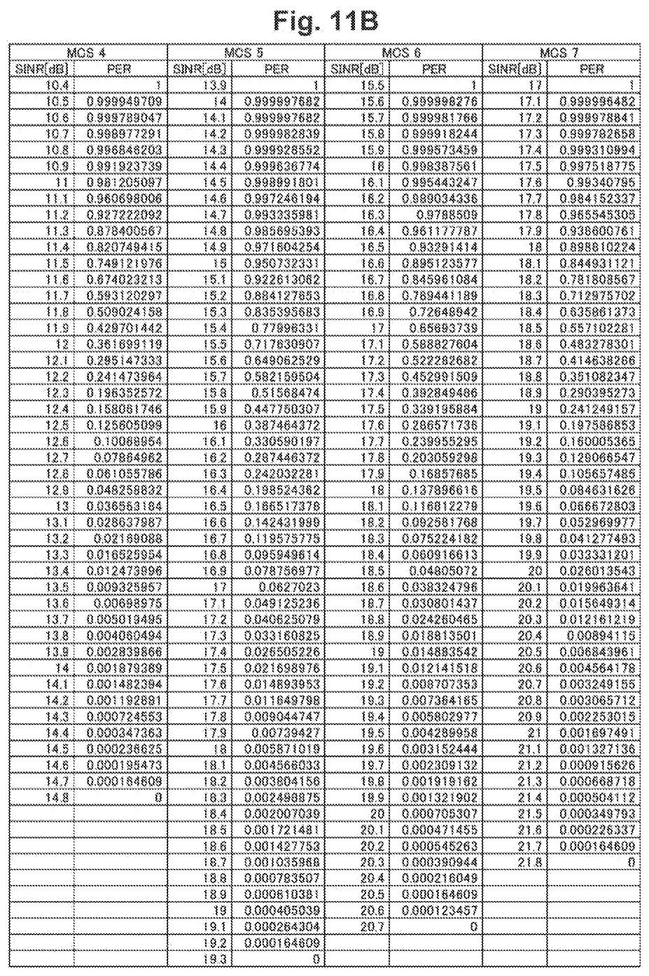

After calculating the SINR, the wireless communication management apparatus 100 determines the PER corresponding to the combination of the collected MTU and MCS and the calculated SINR from the SINR-PER-MCS conversion table. FIGS. 11A and 11B are an example of the SINR-PER-MCS conversion table when the MTU is 1500 bytes. For example, if the MTU is 1500 bytes, the MCS is 7, and the determined SINR is 54 dB, the assumed PER is calculated to be 0 from the SINR-PER-MCS conversion table. That is, in the cell with the MCS of 7, when the SINR is larger than 28.8 dB, the assumed PER is uniformly calculated to be 0. Here, the SINR-PER-MCS conversion table illustrated in FIGS. 11A and 11B is an example, and can be changed as appropriate. For example, in FIGS. 11A and 11B, the SINR is recorded in increments of 0.1 [dB], but the increments of the SINR need not be in increments of 0.1 [dB].

In addition, FIGS. 11A and 11B are an SINR-PER-MCS conversion table when the MTU is 1500 bytes. A similar SINR-PER-MCS conversion table is prepared for each MTU that can be used during wireless communication. The wireless communication management apparatus 100 uses a table corresponding to the collected MTU.

In addition, depending on the wireless environment, MCS cannot be collected in some cases. In this case, the wireless communication management apparatus 100 may estimate the MCS from the RSSI value.

In step S32, the wireless communication management apparatus 100 corrects the collected current PER using the correction value. For example, assuming that the collected current PER is PER_{before}, the correction value is C_{PER}, and the corrected PER is PER_{after}, PER_{after} is calculated from the following (Equation 2). As described above, the correction value C_{PER} is set in advance for each terminal 300.

PER_{after}=PER_{before}−C_{PER} (Equation 2)

In step S33, the wireless communication management apparatus 100 determines whether or not PER_{after}, which is the corrected PER, is different from PER_{calc}, which is the assumed PER. Note that PER_{calc} is derived from the SINR calculated by the above equation (1). For example, the wireless communication management apparatus 100 determines whether or not the difference between PER_{after} and PER_{calc} is equal to or larger than a predetermined threshold T_{PER}. Then, when the difference between PER_{after} and PER_{calc} is equal to or larger than the threshold T_{PER}, the wireless communication management apparatus 100 determines that the PER_{after} and PER_{calc} are different from each other. Here, the threshold T_{PER} can be changed as appropriate. If it is determined in step S33 that PER_{after} and PER_{calc} are different, the processing proceeds to step S34. If it is determined in step S33 that PER_{after} and PER_{calc} are not different, the processing proceeds to step S35.

In step S34, the wireless communication management apparatus 100 calculates a substantial RSSI value from the collected RSSI value. Thereafter, the processing proceeds to step S35. The difference between the collected PER and the assumed PER indicates that the collected PER includes a cause of an error that cannot be detected by the terminal 300. A factor of an undetectable error is, for example, interference from a low power wide area (LPWA) terminal existing around the terminal 300. Due to such a factor of an undetectable error, the RSSI value collected in the terminal 300 is larger than the RSSI value collected during the original wireless communication between the base station and the terminal. In order to curb such variation of the RSSI value due to the influence of interference or the like, the wireless communication management apparatus 100 calculates a substantial RSSI value not including the influence of a factor of an error from the collected RSSI value, and determines the MCS using the substantial RSSI value. The substantial RSSI value is calculated from the SINR calculated from the corrected PER value and the noise floor value. Further, the SINR is calculated from the SINR-PER-MCS conversion table. For example, when the bandwidth is 1 MHz, the MTU is 1500 bytes, the MCS is 7 as described above and PER_{after} is 0.292963, a cell with an MCS of 7 to PER_{after} are values between 0.290395 and 0.351082. In this case, a cell with a PER of 0.351082, which is a cell with a larger PER, i.e, a smaller corresponding SINR, is referenced. Therefore, the SINR calculated from the SINR-PER-MCS conversion table is 18.8 [dB]. In this case, the substantial RSSI value is calculated as −80.2 [dBm] from (Equation 1).

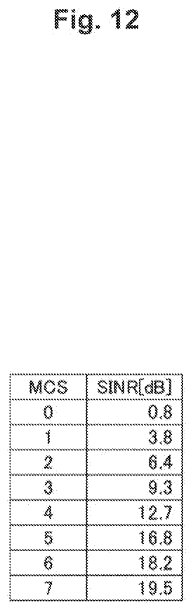

In step S35, the wireless communication management apparatus 100 determines the optimal MCS from the RSSI value by using the SINR-optimal MCS table. Here, when the substantial. RSSI value has not been calculated, the wireless communication management apparatus 100 determines the optimal MCS from the collected RSSI value. On the other hand, when the substantial RSSI value has been calculated, the wireless communication management apparatus 100 determines the optimal MCS from the substantial RSSI value. FIG. 12 is an example of the SINR-optimal MCS table. For example, when the substantial RSSI value is −80.2 [dBm], the SINR is 18.8 [dB]. Therefore, from the SINR-optimal MCS table, the optimal MCS is 6. In addition, when the substantial RSSI value has not been calculated and the collected RSSI value is, for example, −46 [dBm], the SINR is 53 [dB] from (Equation 1) where the bandwidth is 1 MHz. Therefore, from the SINR-optimal MCS table, the optimal MCS is 7.

In step S36, the wireless communication management apparatus 100 determines the MTU that can be transmitted with the determined optimal MCS. The MTU is calculated from the optimal MCS and bandwidth.

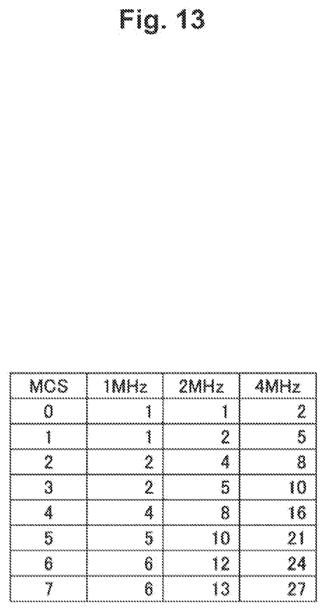

In step S37, the wireless communication management apparatus 100 determines the maximum aggregation number from the determined optimal MCS and bandwidth by using the MCS-aggregation number conversion table. When the processing of step S37 ends, the modulation/demodulation scheme determination processing ends. FIG. 13 is an example of the MCS-aggregation number conversion table. For example, if the optimal MCS is 6 and the bandwidth is 1 MHz, the maximum aggregation number is 6. In this case, a maximum of six MAC protocol data units (MPDUs) are aggregated during wireless communication.

As described above, according to the embodiment, the wireless communication management apparatus 100 evaluates the PER value collected from the terminal 300 after correcting the PER value in consideration of the characteristics of each terminal. As a result, it is possible to correctly evaluate the PER regardless of the difference in characteristics for each terminal.

Further, according to the embodiment, when the collected PER is different from the assumed PER, the MCS is determined using not the collected RSSI but the substantial RSSI. As a result, an optimal MCS can be determined without measuring the influence of a factor of an error of PER such as interference for each terminal. By determining the optimal MCS, an optimal MTU can also be determined. In particular, when a low MCS is selected, if the MTU is not reduced, the reachable distance of the packet by the terminal may be shortened due to restriction by the constraint information, and there is a possibility that communication cannot be performed. According to the embodiment, the MTU is also reduced at the same time when a small MTU is selected, so that the reachable distance of the packet by the terminal can be increased together with the MCS optimization effect.

Hereinafter, modifications of the embodiment will be described. In the embodiment described above, the terminal 300 and the base station 200 wirelessly communicate directly. On the other hand, the terminal 300 and the base station 200 may perform wireless communication via a base station (relay base station) that relays wireless communication.

Further, in the above-described embodiment, it is determined that there is interference when the collected PER and the assumed PER are different. Here, if the terminal 300 is configured to collect channel state information (CSI), the presence or absence of interference may be determined using the CSI instead of or in addition to the determination of whether or not the collected PER is different from the assumed PER. By determining the presence or absence of interference by the CSI, the MCS can be determined more appropriately.

Furthermore, while the above embodiment describes a case where the wireless communication management program is executed by the on-premises wireless communication management apparatus 100, the embodiment is not limited thereto. For example, the wireless communication management program may be executed on a calculation resource on the cloud.

Furthermore, while the above embodiment describes a case where the wireless communication management apparatus 100 is connected to the base station 200 via the network NW, the embodiment is not limited thereto. For example, the wireless communication management apparatus 100 may be provided in the wireless communication system 2 and function as the root base station 200. In this case, the wireless communication management apparatus 100 may be configured to have both functional configuration illustrated in FIGS. 5 and 6 and the functional configuration illustrated in FIG. 7.

Note that the present invention is not limited to the foregoing embodiments and various modifications can be made in the implementation stage without departing from the gist of the invention. In addition, each embodiment may be implemented in appropriate combination, and in that case, combined effects can be obtained. Furthermore, the embodiments described above include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

1 Communication system
2 Wireless communication system
100 Wireless communication management apparatus
200-1, 200-2 Base station
300-1, 300-2, 300-3 Terminal
400 External server
500 Data server
101, 201, 301 Control circuit
102, 202, 302 Memory
103, 203 Wired communication module
104 User interface
105 Timer
106 Drive
107 Storage medium
204, 303 Wireless communication module
304 Sensor
305 Battery
111 User input unit
112, 211 Wired signal reception unit
113 Control information generation unit
114 Determination unit
115, 215 Wired signal transmission unit
116 Command library
212, 311 Wireless signal reception unit
213, 312 Collection unit
214, 313 Update unit
216, 314 Wireless signal transmission unit
1131 Correction unit
1132 Evaluation unit
1133 Determination unit

1. A wireless communication management apparatus comprising a processer including a hardware, configured to
correct, on the basis of a characteristic of each terminal, a first error rate in wireless communication between a base station and the terminal based on first wireless environment information collected from one or more terminals configured to wirelessly communicate with the base station;
evaluate a second error rate obtained by correction; and
determine a modulation/demodulation scheme for wireless communication for each of the terminals on the basis of a result of the evaluation.

2. The wireless communication management apparatus according to claim 1, wherein
the processor
determines the modulation/demodulation scheme by using the first wireless environment information when a difference between the second error rate and a third error rate assumed in a wireless environment in which there is no interference in wireless communication between the base station and the terminal is small, and
determines the modulation/demodulation scheme by using second wireless environment information calculated from the second error rate when a difference between the second error rate and the third error rate is large.

3. The wireless communication management apparatus according to claim 1, wherein
the processor further determines a packet size for wireless communication for each of the terminals by using the modulation/demodulation scheme.

4. The wireless communication management apparatus according to claim 1, wherein the processor performs the evaluation on the basis of interference information collected in the terminal.

5. The wireless communication management apparatus according to of claim 1, wherein the terminal is an IoT terminal.

6. A wireless communication management method comprising:
correcting, on the basis of a characteristic of each terminal, a first error rate in wireless communication between a base station and the terminal based on first wireless environment information collected from one or more terminals configured to wirelessly communicate with the base station;
evaluating a second error rate obtained by correction; and
determining a modulation/demodulation scheme for wireless communication for each of the terminals on the basis of an evaluation result.

7. A non-transitory storage medium storing a wireless communication management program for causing a processor to execute:
correcting, on the basis of a characteristic of each terminal, a first error rate in wireless communication between a base station and the terminal based on first wireless environment information collected from one or more terminals configured to wirelessly communicate with the base station;
evaluating a second error rate obtained by correction; and
determining a modulation/demodulation scheme for wireless communication for each of the terminals on the basis of an evaluation result.
